(19) United States
(12) Patent Application Publication
(10) Pub. No.: US 2026/0194895 A1
(43) Pub. Date: Jul. 9, 2026

(54) DATA FLOW ANALYSIS IN AN INDUSTRIAL NETWORK

(71) Applicant: Honeywell International Inc., Charlotte, NC (US)

(72) Inventor: Alexey (Eli) Khitrov, Tel Aviv (IL)

(21) Appl. No.: 19/012,919

(22) Filed: Jan. 8, 2025

(51) Int. Cl. G05B 23/02

(52) U.S. Cl. CPC G05B 23/0275; G05B 23/0221

(57) ABSTRACT

Approaches for monitoring and analyzing flow of data in an industrial control network to detect a discrepancy are described. In an example, the discrepancy is indicative of at least one of an intrusion, a cyber-attack, a network failure, a communication error, a sensor malfunction, and a process anomaly. In an example, correlated time-series data sets corresponding to different segments of the industrial control network are obtained, wherein each time-series data set corresponds to a target variable. To obtain these time-series data sets, data stream flowing through the industrial control network is monitored at multiple points through network switches corresponding to different segments and processed to obtain the correlated time-series data sets. Once obtained, discrepancy identification is performed by comparing the variable values between correlated time-series data sets across segments. When inconsistencies between variable values across segments are detected, appropriate alerts are generated to notify an operator.

### BACKGROUND

Industrial control systems rely on the seamless flow of data across its various network segments to monitor and manage critical processes. From field devices capturing raw sensor data to human-machine interfaces providing operational oversight, the integrity and consistency of this data are paramount for efficient and safe operations. As industrial control networks grow more complex, ensuring data integrity across all segments becomes increasingly important. Discrepancies in data, whether caused by network faults, sensor malfunctions, or malicious interventions, may lead to misinformed decision-making and compromise operational safety. The continuous monitoring and detection of inconsistencies in real-time, and timely alerting of operators to potential issues are important for maintaining the reliability and security of industrial control systems.

### BRIEF DESCRIPTION OF FIGURES

Systems and/or methods, in accordance with examples of the present subject matter are now described and with reference to the accompanying figures, in which:

FIG. 1 illustrates a computing system for identifying a discrepancy within an industrial control network, as per an example;

FIG. 2 illustrates an industrial control network comprising a discrepancy detection system, as per an example;

FIG. 3 illustrates a detailed block diagram of a discrepancy detection system, as per an example;

FIGS. 4-7 illustrate an industrial control network in various scenarios related to discrepancy detection, as per an example;

FIG. 8 illustrates a method for identifying a presence of discrepancy within an industrial control network, as per an example;

FIG. 9 illustrates a detailed method for identifying the presence of discrepancy within an industrial control network, as per an example;

FIG. 10 illustrates another method for identifying a presence of discrepancy within an industrial control network, as per another example; and

FIG. 11 illustrates a system environment implementing a non-transitory computer readable medium for identifying a discrepancy within an industrial environment, as per an example.

### DETAILED DESCRIPTION

Industrial control networks form the backbone of modern automated control systems, comprising various interconnected segments that work in combination with each other to monitor, control, and optimize industrial processes. These segments typically include sensors at the lowest level, which gather raw data from the physical environment. This raw data then flows to Programmable Logic Controllers (PLCs), which act as the local intelligence, processing inputs and controlling various equipment comprised in the segments based on predefined logic. Above the PLC layer, Supervisory Control and Data Acquisition (SCADA) systems provide a broader view, coordinating multiple PLCs and offering centralized view to the entire operation. Operators then interact with these complex systems through Human-Machine Interfaces (HMIs), which translate data into comprehensible visual displays and control panels. Subsequently, to support long-term analysis and decision making, historian databases capture and store vast amounts of operational data over time.

In industrial control networks, different segments use various ways to communicate with each other. This is because each level deals with different types of information, uses technology from different makers, and has its own special needs. For instance, sensors may use simple serial protocols, PLCs might employ industrial Ethernet protocols, while SCADA systems may utilize higher-level protocols. Data, in such networks, usually moves up through the various segments of the network, from simpler parts to more complex ones. This helps operators to monitor what's happening right now, make decisions, look at past information, and follow various rules based on the situation. However, this data flow is susceptible to disruptions or alterations at various points along its path, particularly at segment junctions where protocol translations occur.

Several factors may affect data integrity during such movement of data in the industrial control network. Examples of some of such factors include, but are not limited to, intrusion in the industrial control network, a cyber-attack, a network failure, a communication error, a sensor malfunction, and a process anomaly, which may all lead to data inconsistencies or data loss. These issues may occur at any segment, from sensor mis-readings to data corruption in historians. Various approaches have been employed to address data integrity and security challenges in industrial control networks. These include the implementation of redundancy systems to ensure continuous operation in case of component failures, data validation checks to verify the accuracy of transmitted information, and intrusion detection systems to identify unauthorized access attempts. Some industrial control systems utilize data reconciliation techniques, which aim to identify and rectify discrepancies between related measurements across different network segments. Additionally, many organizations conduct regular system audits and integrity checks as part of their standard operational procedures to maintain the overall health and security of their industrial control networks.

However, these conventional approaches have several limitations. They often operate within isolated segments, lacking a holistic view of the entire data flow across the network. This segmented approach may miss inconsistencies that only become apparent when comparing data across different protocols or segments. Additionally, many conventional systems struggle to handle the increasing complexity and volume of data in modern industrial control networks, leading to delayed detection of issues or false positives. Furthermore, conventional methods typically rely on predefined rules or thresholds, which may not adapt well to the dynamic nature of industrial processes. They often fail to account for the complex interrelationships between variables across different segments of the network. This may result in missed detections of sophisticated attacks. Lastly, many existing solutions focus primarily on cybersecurity threats, overlooking the equally important issues of data integrity and system reliability that may arise from non-malicious sources such as misconfigurations or equipment failures.

Approaches for monitoring and analyzing flow of data in an industrial control network to detect a discrepancy are described. In an example, the discrepancy is indicative of one of an intrusion in the industrial control network, a cyber-attack, a network failure, a communication error, a sensor malfunction, or a process anomaly. The detection of discrepancies within the industrial control networks may be used to enhance operational safety, improve cybersecurity posture, optimize process efficiency, and ensure data integrity across different segments of the industrial control system. By continuously monitoring and correlating data from multiple network segments, these approaches enable rapid identification of discrepancy (or anomaly) that may potentially compromise the reliability, security, and/or performance of industrial operations.

In an example, a system implementing the above referenced approaches obtains correlated pairs of time-series data sets corresponding to different segments of an industrial control network, wherein each pair corresponds to a target variable. The system monitors data at multiple points in the industrial control network through network switches corresponding to different segments. While the examples described may reference two segments, the system is capable of monitoring and analyzing any number of segments within the industrial control network.

Continuing further, the system processes data streams from the network switches to extract variable identifiers and their corresponding values. These variable identifiers may include tag names, memory addresses, or other unique identifiers used within the industrial control system. The system then generates time-series data sets for each segment by organizing the extracted variable values chronologically. Through correlation analysis, the system identifies pairs of time-series data sets across segments that correspond to the same target variable, enabling tracking of how process variables propagate through different layers of the industrial control network.

Thereafter, the system performs discrepancy identification by comparing the variable values between correlated time-series data sets across segments. This comparison helps identify various types of anomalies including intrusions, cyber-attacks, network failures, communication errors, sensor malfunctions, or process anomalies. When the system detects inconsistencies between variable values across segments, it generates appropriate alerts to notify an operator.

In an example, the system's discrepancy detection capabilities are enhanced through integration with historical data stored in a data historian. For example, when variable values appear consistent across segments, the system may retrieve historical baseline patterns indicating normal behavior for the target variable. By comparing current time-series data sets against these baseline patterns, the system may identify deviations that may indicate discrepancies even when the data appears consistent between segments. Additionally, the system considers relationships between variables when performing discrepancy detection. By analyzing relationship data from historians indicating how variables are interconnected, the system may identify discrepancies in the target variable based on inconsistencies detected in related variables, even when the target variable's own time-series data set appears consistent across segments.

In an example, once the presence of discrepancy within the industrial control network is confirmed, the system provides visual representations of the identified discrepancies through a user interface. The visual representations includes timelines of the time-series data sets, color-coded discrepancy indicators, network segment icons, animated data flow paths showing discrepancy locations, and interactive pop-ups with discrepancy details and severity scales.

In another example, rather than obtaining data streams from multiple network switches simultaneously, the system may obtain a first data stream from a first network switch in a first segment of the industrial control network and parse it to extract variable identifiers and values corresponding to a target variable. From this parsed data, the system generates a first time-series data set. Instead of obtaining a second data stream from another network switch, the system directly retrieves a second time-series data set for the same target variable from a remote database or remote device, where this second time-series data set corresponds to a second segment of the industrial control network. The system then performs discrepancy detection by comparing these two time-series data sets to identify potential discrepancy (or anomalies) such as intrusions, cyber-attacks, network failures, communication errors, sensor malfunctions, or process anomalies. When inconsistencies are detected between the variable values in these time-series data sets, the system generates appropriate alerts.

The present subject matter provides a number of technical advancements in industrial control network monitoring and security systems. By leveraging real-time data processing and advanced analytics techniques, the system provides an adaptive approach for detecting discrepancies across various segments of an industrial control network. Unlike existing systems that may focus on isolated components, the present subject matter continuously analyzes data flows across multiple network layers, including field devices, PLCs, SCADA systems, and HMIs, to generate a comprehensive view of network integrity. This approach allows for more precise and context-specific anomaly detection, potentially identifying subtle discrepancies that might otherwise go unnoticed while providing earlier warnings of potential security threats or system malfunctions.

The system's ability to correlate data from different network segments and visualize discrepancies in real-time further enhances its value, offering operators proactive guidance and improving overall situational awareness. By integrating these advanced computational methods with real-time data feeds and intuitive visual interfaces, the present subject matter significantly enhances the decision-making capabilities of industrial operators and security personnel. This potentially leads to improved operational safety, increased cybersecurity, and enhanced process efficiency across a wide range of industrial environments and control system configurations.

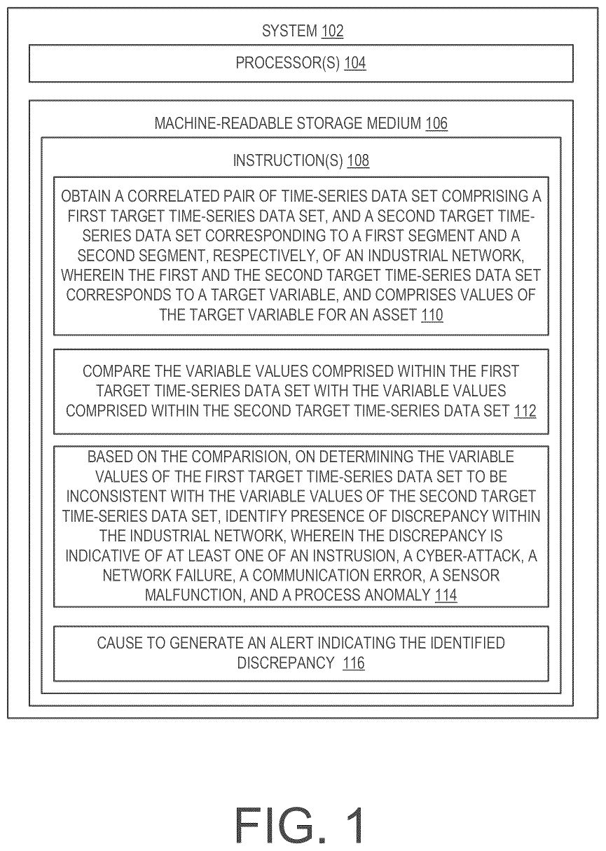

FIG. 1 illustrates an exemplary system 102 for detecting discrepancies in an industrial control network. In an example, the discrepancy in the industrial environment is indicative of one of an intrusion, a cyber-attack, a network failure, a communication error, a sensor malfunction, a process anomaly, or combination thereof. The system 102 includes a processor 104, and a machine-readable storage medium 106 which is coupled to, and accessible by, the processor 104. The system 102 may be implemented in any computing system, such as an on-site industrial computer, a remote server, a distributed computing system, or the like. Although not depicted, the system 102 may include other components, such as interfaces to communicate over the network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to detect discrepancies in the industrial control network.

In an example, the processor 104 may fetch and execute instructions 108. As a result of the execution of the instructions 110, the system 102 may obtain a correlated pair of time-series data sets. This pair includes a first target time-series data set and a second target time-series data set corresponding to a first segment and a second segment, respectively, of the industrial control network. In an example, both data sets, i.e., the first target time-series data set and the second target time-series data set, correspond to a target variable and comprise values of the target variable for an asset installed within the industrial control network. In one example, the data sets may be obtained from various sources such as industrial control systems, sensors, or data historians within the industrial control network.

Once obtained, the instructions 112 may be executed to compare the variable values comprised within the first target time-series data set with the variable values comprised within the second target time-series data set. In an example, this comparison may involve various statistical methods, time-series analysis techniques, or machine learning algorithms to detect differences or inconsistencies between the two data sets.

The instructions 114 may then be executed to determine if the variable values of the first target time-series data set are inconsistent with the variable values of the second target time-series data set, thereby identifying the presence of the discrepancy within the industrial control network. This determination may be based on predefined thresholds, statistical significance tests, or anomaly detection algorithms tailored to the specific industrial process or asset being monitored. In an example, the discrepancy may be indicative of at least one of a network attack, a network failure, a communication error, a sensor malfunction, a process anomaly, or combination thereof. The identification process may involve analyzing patterns, trends, or anomalies in the obtained target time-series data sets.

Finally, the instructions 116 may be executed to cause the generation of an alert indicating the identified discrepancy. In an example, the alert may take various forms, such as visual notifications on a control panel, automated emails to system administrators, or integration with existing alarm systems. The alert serves to promptly inform relevant personnel about the identified discrepancy, enabling timely intervention and mitigation of potential issues in the industrial control network.

The above functionalities performed as a result of the execution of the instructions 108, may be performed by different programmable entities. Such programmable entities may be implemented through various computing systems, which may be implemented either on a single computing device, or multiple computing devices. As will be explained, various examples of the present subject matter are described in the context of a computing system for detecting discrepancies in industrial control networks by comparing correlated time-series data sets from different network segments. These and other examples are further described with respect to other figures.

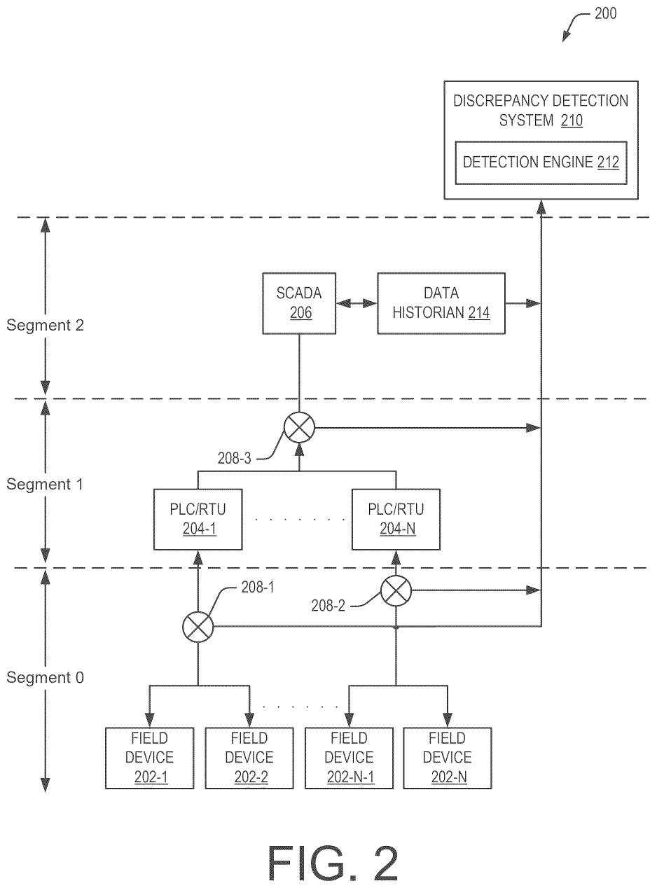

FIG. 2 illustrates a multi-layered industrial control network 200 corresponding to an industrial facility, in accordance with one example of the present subject matter. The industrial control network 200 may segmented into multiple layers or segments, each serving distinct functions within the industrial facility. These segments are interconnected to facilitate data flow and control operations across various levels of the industrial process, from field devices to supervisory systems. For example, as depicted in FIG. 2, the industrial control network 200 (referred to as network 200) is segmented into three distinct segments, namely, ‘segment 0’, ‘segment 1’, and ‘segment 2’, each serving specific functions and housing specialized equipment. It should be understood that the network 200 may comprise any number of segments or layers, depending on the specific requirements and complexity of the industrial facility. The present subject matter is not limited to the number of segments illustrated herein and may be applied to networks with fewer or additional segments as needed.

It may be noted that, the segments depicted in FIG. 2 are described from the perspective of a Purdue model, which is commonly used to represent the hierarchical structure of industrial control networks. However, it should be understood that the nomenclature used to name these segments may vary depending on the specific model or framework employed in a particular industrial facility. For instance, while the present example uses terms like “segment 0” for the field level and “segment 1” for the control level, other industrial environments may use different naming conventions or layer designations. These variations in terminology do not deviate from the scope of the present subject matter. The core concept of analyzing data flows between different hierarchical levels of the industrial control network to detect discrepancies remains applicable regardless of the specific naming convention or model used. The system and methods described herein are adaptable to various industrial control network architectures and may be implemented across different segmentation models without deviating from the scope of the present subject matter.

Continuing further, At the foundation, the network 200 includes a ‘segment 0’, which may be also known as a field level segment. In an example, this segment is populated with an array of field devices, represented by field device 202-1, field device 202-2, field device 202-(N-1), and field device 202-N (collectively referred to as field device(s) 202). These field device(s) 202 encompass a wide range of equipment such as sensors (e.g., temperature, pressure, flow, level sensors), actuators (e.g., valves, motors), transmitters, and other instrumentation. Field device(s) 202 serve as the primary interface with the physical processes, continuously monitoring and controlling various aspects of the industrial operations. In an example, these field device(s) 202 capture real-time data related to operational parameters, environmental conditions, and status of assets installed within the industrial facility.

It may be noted that the examples of assets may vary depending on the type of industrial facility and the industrial process to be carried out in the industrial facility. For instance, in an automobile assembly facility, assets may include robotic arms, conveyor belts, welding machines, and paint sprayers; in a pharmaceutical production facility, assets may include mixing tanks, centrifuges, tablet presses, and packaging machines; in a power plant, assets may include turbines, generators, boilers, and cooling towers; in a food processing plant, assets may include ovens, mixers, packaging machines, and refrigeration units; in a warehouse and distribution center, assets may include conveyor systems, automated guided vehicles (AGVs), sorting machines, and inventory management systems; in an oil refinery, assets may include distillation columns, heat exchangers, pumps, and compressors; and in a water treatment facility, assets may include filtration systems, chemical dosing equipment, pumps, and monitoring sensors.

Moving up the hierarchy in the network 200, ‘segment 1’ represents a control level segment. In an example, this segment includes a plurality of Programmable Logic Controllers (PLCs) 204-1, . . . , 204-N (collectively referred to as PLC(s) 204) connected to field device(s) 202. In an example, these PLC(s) 204 are robust, industrialized computing devices designed to withstand harsh environments. They receive inputs from the field device(s) 202 of ‘segment 0’, process this information based on pre-programmed logic, and send control signals back to the field device(s) 202. PLC(s) 204 helps in maintaining automated processes, ensuring real-time control and response to changing conditions on the field level. For instance, the PLC(s) 204 may receive operational data corresponding to the plurality of assets from various field device(s) 202 which are associated with the plurality of assets, process the operational data according to predefined logic or algorithms, and then send appropriate control signals to actuators or other control mechanisms on the plurality of assets.

At the apex of this network 200 is ‘segment 2’, a supervisory level segment. In an example, this segment includes Supervisory Control and Data Acquisition (SCADA) server 206 which aggregates data from multiple PLC(s) 204 and other sources across the network 200. The SCADA server 206 may provide a centralized platform for monitoring and controlling various industrial processes and assets. The SCADA server 206 may offer features such as real-time data visualization, historical data trending, alarm management, and report generation. In some examples, the SCADA server 206 may also implement advanced analytics and machine learning algorithms to predict equipment failures or optimize process efficiency. Working in tandem with the SCADA server 206 is a Human-Machine Interface (HMI) (which is not shown in FIG. 2). The HMI serves as the primary point of interaction for operators, displaying critical system information, alarms, and controls in a user-friendly format. The HMI may be implemented as a dedicated hardware terminal, a PC-based software application, or even a mobile device, providing operators with real-time visualization of process data, system status, and control capabilities.

Continuing further, the network 200 further include a plurality of network switches 208-1, 208-2, and 208-3 (referred to as network switch(s) 208) which interconnect these segments. These network switch(s) 208 are industrial-grade networking devices, designed to operate reliably in challenging industrial environments. Network switch(s) 208 facilitate the seamless flow of data between different segments, ensuring that information from field device(s) 202 reaches the PLC(s) 204, and subsequently, to the SCADA server 206. These switches often support various industrial protocols, enabling integration of devices from different manufacturers and of different generations. Although, FIG. 2 depicts the network 200 with adjacent segments connected by different network switch(s) 208, it's important to note that this representation is not limiting. In practice, a single network switch, e.g., network switch 208-1 may serve as an interconnection point between more than two segments within the network 200.

Further, in the industrial control network depicted in FIG. 2, due to variations in hardware configurations, proprietary technologies, and differences in manufacturers, the equipment across the network 200 may operate using diverse communication protocols. These differences in protocols are also influenced by the type of segment within the industrial control network. For instance, ‘segment 0’, which includes field devices like sensors and actuators, typically communicates with ‘segment 1’, the control level with PLCs, using analog communication protocols or industrial digital protocols such as Modbus or Profibus. Further, ‘segment 1’ communicates with ‘segment 2’, the supervisory level featuring SCADA systems, using more advanced network protocols that might include Ethernet industrial protocol (Ethernet/IP) or Modbus Transmission Control Protocol (TCP) for enhanced data transmission capabilities. Examples of such protocols include, but are not limited to, EtherCAT, ControlNet, and DeviceNet, which facilitate robust and efficient data exchanges across different segments and equipment, accommodating the unique operational demands and integration requirements of each segment.

The network 200 further includes a discrepancy detection system 210 which taps into data streams flowing through the network switch(s) 208, collecting information from all segments of the network 200. In an example, the discrepancy detection system 210 (referred to as system 210) uses “port mirroring” or “port spanning” with the network switch(s) 208 to obtain data streams flowing through different network switches. As depicted in FIG. 2, the system 210 is connected with the network switch(s) 208 positioned at various locations along the network 200 to obtain data streams corresponding to different segments of the network 200. The system 210 may further include a detection engine 212, which employs algorithms to analyze the obtained data streams in real-time. The detection engine 212 is configured for identifying any discrepancies, anomalies, or potential security threats within the network 200. For example, by comparing data included within the data streams from different network segments and analyzing patterns, the detection engine 212 may detect issues such as sensor malfunctions, communication errors, cyber attack, intrusion, etc. Once the discrepancy or anomaly is detected within the network 200, the detection engine 212 is configured to generate an alert for the operator. This alert is designed to provide comprehensive information about the detected issue, enabling quick and informed decision-making. The alert may be displayed on the HMI or sent to other relevant systems within the network 200.

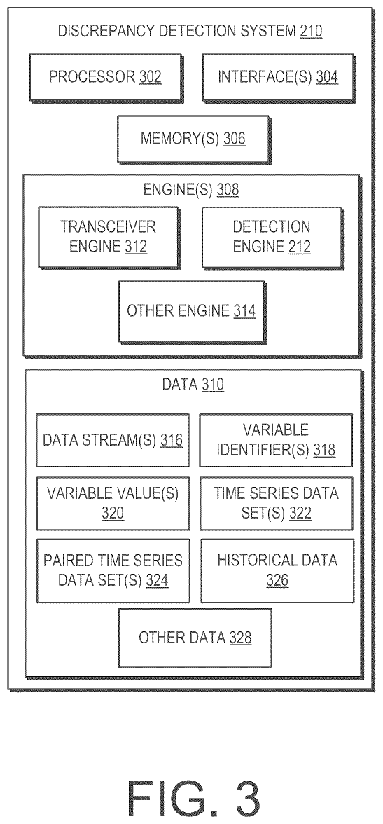

FIG. 3 depicts various functional blocks of the system 210, as per an example. The system 210 includes processor 302, interface(s) 304, and memory(s) 306. The processor 302 may be implemented as microprocessors, microcomputers, microcontrollers, digital signal processors, central processing units, state machines, logic circuitries, and/or other devices that manipulate signals based on operational instructions. The interface(s) 304 may allow the connection or coupling of the system 210 with one or more other devices, through a wired (e.g., Local Area Network, i.e., LAN) connection or through a wireless connection (e.g., Bluetooth®, Wi-Fi). The interface(s) 304 may also enable intercommunication between different logical as well as hardware components of the system 210. The interface(s) 304 may also enable the system 210 to communicate with other entities, such as the network switch(s) 208, HMIs, or other devices or systems.

The memory(s) 306 may be a computer-readable medium, examples of which include volatile memory (e.g., RAM), and/or non-volatile memory (e.g., Erasable Programmable read-only memory, i.e., EPROM, flash memory, etc.). The memory(s) 306 may be an external memory, or internal memory, such as a flash drive, a compact disk drive, an external hard disk drive, or the like. The memory(s) 306 may further include data which either may be utilized or generated during the operation of the system 210.

The system 210 may further include engine(s) 308 and data 310. The engine(s) 308 may be implemented as a combination of hardware and programming, for example, programmable instructions to implement a variety of functionalities of the engine(s) 308. In examples described herein, such combinations of hardware and programming may be implemented in several different ways. For example, the programming for the engine(s) 308 may be executable instructions. Such instructions may be stored on a non-transitory machine-readable storage medium which may be coupled either directly with the system 210 or indirectly (for example, through networked means). In an example, the engine(s) 308 may include a processing resource, for example, either a single processor or a combination of multiple processors, to execute such instructions. In the present examples, the non-transitory machine-readable storage medium may store instructions that, when executed by the processing resource, implement engine(s) 308. In other examples, the engine(s) 308 may be implemented as electronic circuitry.

The engine(s) 308 includes a transceiver engine 312, detection engine 212, and other engine(s) 314. The other engine(s) 314 may further implement functionalities that supplement functions performed by the system 210 or any of the engine(s) 308. The data 310, on the other hand, includes data that is either stored or generated as a result of functions implemented by any of the engine(s) 308 or the system 210. It may be further noted that information stored and available in data 310 may be utilized by the engine(s) 308 for performing various functions to be implemented by the system 210. In an example, data 310 may include data stream(s) 316, variable identifier(s) 318, variable value(s) 320, time-series data set(s) 322, paired time-series data set(s) 324, historical data 326, and other data 328. It may be noted that such examples of the various functional blocks as depicted in FIG. 3 are indicative. The present approaches may be applicable to other examples without deviating from the scope of the present subject matter.

The working of the system 210 (via functional blocks as depicted in FIG. 3) is explained in conjunction with various elements of the network 200 (as described in FIG. 2). In operation, the transceiver engine 312 of the system 210 is configured to obtain a first data stream and a second data stream from network switch(s) 208 corresponding to first and second segments of the network 200. The system 210 stores these obtained data streams in data stream(s) 316 of data 310. Specifically, a first data stream is obtained from the network switch 208-1 associated with the first segment, which may be ‘segment 0’ (i.e., the field level segment). In an example, the first data stream may include information from field devices such as field device(s) 202. Simultaneously, a second data stream is obtained from another network switch 208-3 which may be associated with the second segment, which may be ‘segment 1’ (i.e., at the control level segment) including data from PLCs such as PLC(s) 204. It should be noted that while the present example is described in the context of first and second segments, the network 200 may comprise any number of segments. The system 210 is capable of analyzing data from multiple segments simultaneously, applying the same principles of discrepancy detection across all available network layers to provide comprehensive monitoring and analysis of the entire network 200.

In an example, the data stream(s) 316 comprise information corresponding to a plurality of variables that are indicative of operating parameters of various assets within the industrial facility. For instance, the first data stream from ‘segment 0’ might include raw sensor data from field devices, such as temperature readings, pressure measurements, flow rates, and equipment status indicators. The second data stream from ‘segment 1’ may include processed data from PLC(s) 204, including control signals, setpoints, and calculated process variables.

Once obtained, the system 210, through its detection engine 212, is configured to parse the obtained data stream(s) 316. When parsing the first data stream from the network switch 208-1 in ‘segment 0’, the detection engine 212 extracts a first set of variable identifiers and their corresponding values. In an example, these variable identifiers may include unique tags or addresses for specific sensors or field devices (e.g., “TT101” for a temperature transmitter, “FT202” for a flow transmitter). The corresponding values would be the actual measurements or states of these devices (e.g., 85.5° C. for TT101, 500 L/min for FT202).

Similarly, when parsing the second data stream from the network switch 208-3 in ‘segment 1’, the detection engine 212 extracts a second set of variable identifiers and their corresponding values. At this level, the variable identifiers may be PLC memory addresses or tag names (e.g., “DB1.DBW0” for a data block in a Siemens PLC, or “Tank1_Level” for a named variable). The corresponding values would be the processed or calculated values used by the PLCs (e.g., a scaled temperature value, a control output percentage). The system 210 stores the first set of variable identifiers and the second set of variable identifiers in the variable identifier(s) 318 of the data 310. Correspondingly, the system 210 stores the variable values associated with the first set of variable identifiers and the second set of variable identifiers in the variable value(s) 320 of the data 310. This structured storage approach allows for efficient organization and retrieval of both the identifiers and their associated values, facilitating subsequent analysis and comparison operations performed by the system 210.

Once determined, the detection engine 212 generates time-series data sets based on the extracted variable value(s) 320. For the first set of variable identifiers from ‘segment 0’, the detection engine 212 creates a first set of time-series data sets. In an example, each time-series in this set corresponds to a specific variable identifier (e.g., a sensor tag) and contains a sequence of values over time. Similarly, for the second set of variable identifiers from ‘segment 1’, the detection engine 212 generates a second set of time-series data set, each corresponding to a PLC variable or tag. For example, a time-series in the first set might represent temperature readings from a specific sensor (field device 202-1) over time, while a time-series in the second set might represent the processed temperature values used by a PLC (PLC 204-1) for the same process variable. The system 210 stores the first set of time-series data set and the second set of time-series data set in the time-series data set(s) 322 of the data 310.

Thereafter, the detection engine 212 correlates the first set of time-series data set with the second set which are stored in the time-series data set(s) 322. In an example, this correlation process involves identifying pairs of time-series data sets that likely represent the same underlying process variable as it moves through different segments of the network 200. For instance, it might correlate the raw temperature sensor readings from ‘segment 0’ with the processed temperature values used by the PLC in ‘segment 1’. The result of this correlation is a set of paired time-series data set, where each pair consists of a “first target time-series data set” selected from the first set of time-series data set and a “second target time-series data set” selected from the second set of time-series data set. These correlated pairs represent the same process variables as observed at different points in the network 200, enabling the system 210 to track how data changes as it moves through the network hierarchy. The system 210 stores the set of paired time-series data sets in paired time-series data set(s) 324 of the data 310.

Once the correlated pair of time-series data sets, i.e., the paired time-series data set(s) 324 are obtained, the detection engine 212 obtains a correlated pair of time-series data set from the paired time-series data set(s) 324 corresponding to a target variable. This correlated pair comprises a first target time-series data set and a second target time-series data set corresponding to the first segment and the second segment, respectively, of the network 200. Both data sets in the pair correspond to the same target variable and contain values of that variable for a specific asset over a defined time period.

Thereafter, the detection engine 212 compares the variable values included within the first target time-series data set (e.g., raw sensor data from the field device 202-1 in ‘segment 0’) with the variable values included within the second target time-series data set (e.g., processed data from the PLC 204-1 in ‘segment 1’). As described above, the paired time-series data set(s) 324 includes one or more pair of time-series data sets, from which a single pair, corresponding to a target variable, is selected and variable values comprised within respective time-series data sets of the pair are compared. In an example, this comparison is performed point by point across the time-series, analyzing how the values of the target variable change or remain consistent as they move through different segments of the network 200.

Based on the comparison, if it is determined that the variable values in the first target time-series data set are inconsistent with the values in the second target time-series data set, the detection engine 212 identifies the presence of a discrepancy within the network 200. Examples of inconsistencies include, but are not limited to, unexpected deviations, delays, or alterations in the data as it moves from one segment to another. For example, if a temperature sensor in the field device segment (‘segment 0’) reports a gradual increase from 25° C. to 30° C. over a 5-minute period, but the corresponding data in the PLC segment (‘segment 1’) shows a sudden jump from 25° C. to 30° C., this inconsistency in the rate of change could indicate a communication error, data manipulation, or a fault in the data transmission process between the two segments.

Upon identifying a discrepancy, the detection engine of the system 210 generates an alert to indicate the detected issue. In an example, this alert may be sent to the HMI for immediate operator attention, logged in a data historian 214 for future analysis, or transmitted to other relevant systems within the network 200. The alert serves to promptly inform operators or personnel about potential issues in the network 200, enabling quick response and mitigation of any detected problems, thereby maintaining the integrity and security of the industrial operations.

On the other hand, upon determining that the variable values of the first target time-series data set (from ‘segment 0’) are consistent with the values of the second target time-series data set (from ‘segment 1’), the detection engine 212 doesn't immediately conclude that no discrepancy exists. Instead, the detection engine 212 analyse the current time-series data set (i.e., first time-series data set or second time-series data set) with historical data stored within a data historian 214. In an example, the historical data includes a plurality of baseline time-series data sets that represent normal or actual behavior for various variables across different assets in the network 200. The detection engine 212 then retrieves the historical data from the data historian 214 and store as historical data 326 in system 210 and uses this historical data 326 in combination with the current first and second target time-series data sets to identify potential discrepancies that may not be apparent from just comparing the two current data sets.

To identify discrepancies using this historical data 326, the detection engine 212 obtains a specific baseline time-series data set from the historical data 326 that corresponds to the target variable being analyzed. The detection engine 212 then compares the variable values of either the first or second target time-series data set (or both) against this baseline time-series data set. Based on the comparison, if the detection engine 212 detects a significant deviation between the current data and the baseline time-series data set, it identifies this as the discrepancy within the network 200, even though the current data from different segments appeared consistent, and generate the alert indicating the discrepancy.

In yet another example, the system 210 may perform a more sophisticated analysis by considering relationships between variables. For example, even when the time-series data set for the target variable appears consistent across segments, the detection engine 212 retrieves a relationship data from the data historian 214. The relationship data indicates how the target variable typically related with changes occurring within other variables in the industrial process. The detection engine 212 then analyzes the values of these related variables across different segments. If inconsistencies are detected in these related variables, the detection engine 212 may infer that a discrepancy exists in the target variable, despite its apparent consistency.

Once the discrepancy within the network 200 is confirmed, to effectively communicate identified discrepancies, the detection engine 212 of the system 210 may generates a comprehensive visual representation on the HMI or another user interface. In an example, this visualization representation includes a timeline displaying both the first and second target time-series data sets, allowing operators to see how the data evolves over time across different segments. In another example, color-coded indicators may also be used as visual representation to highlight discrepancies, making them easily noticeable. Further, icons representing different network segments (such as field devices 202-1 to 202-N, PLCs 204-1 to 204-N, and SCADA server 206) are included to provide context for where discrepancies occur within the network topology. In another example, animated data flow paths visually demonstrate how data moves through the network and pinpoint exact locations where discrepancies arise. For more detailed information, the interface includes interactive pop-ups that provide specific details about each discrepancy and a severity scale to help prioritize responses.

While the description of FIG. 2 and FIG. 3 primarily focuses on an example involving a first segment and a second segment of the network 200, it is important to note that the system 210 is not limited to this configuration. The approaches described herein are equally applicable to industrial control networks comprising any number of segments, from simple two-segment architectures to complex multi-tiered networks with numerous interconnected segments. The system 210 is designed to be scalable and adaptable, capable of analyzing data flows and identifying anomalies across multiple segments simultaneously. Whether the network includes additional intermediate layers between field devices and SCADA systems, incorporates multiple parallel processing paths, or integrates diverse subsystems, the core principles of data correlation, comparison, and anomaly detection remain applicable.

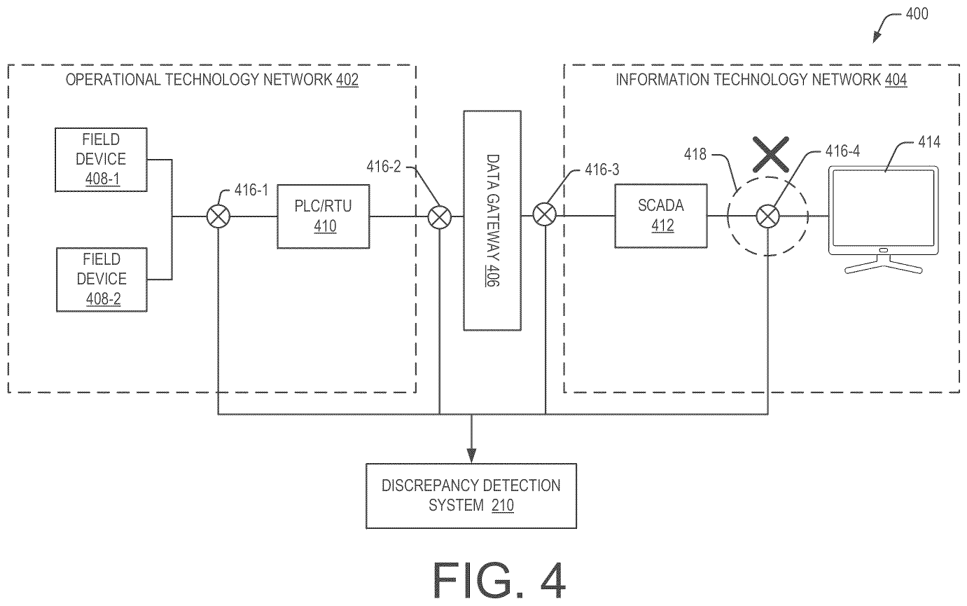

Different exemplary scenarios of discrepancy within the network 200 are explained in conjunction with FIGS. 4 to 7. These figures provide explanation regarding various types of anomalies and security threats that the system 210 is designed to identify and address. It may be noted that the scenarios explained in FIGS. 4 to 7 are exemplary and the system 210 is capable of identifying discrepancy in other scenarios as well without deviating from the scope of the present subject matter.

FIG. 4 depicts an industrial control network 400 illustrating a scenario where a discrepancy occurs due to a connection fault between a SCADA server and an HMI. The industrial control network 400 includes an operational technology network 402 and an information technology network 404 interconnected with each other via data gateway 406. In an example, the operational technology network 402 comprises field devices 408-1 and 408-2, which may be sensors or actuators, connected to a PLC/RTU 410 (Programmable Logic Controllers/Remote Terminal Unit) through network switch 416-1. The information technology network 404 includes a SCADA server 412 and an HMI 414, also connected via network switch 416-4. The industrial control network 400 further includes a discrepancy detection system, such as system 210, for monitoring data flows across both networks to identify potential issues.

In real-time, the system 210 begins by obtaining time-series data sets from multiple points, i.e., from network switches 416-1, 416-2, 416-3, and 416-4, within the network 200. For example, the system 210 collects data corresponding to the field devices 408-1 and 408-2 in the operational technology network 402 from the network switch 416-1, representing raw sensor readings and actuator states. It then gathers data corresponding to the PLC/RTU 410 from network switch 416-2, which includes processed values and control signals. Moving up the hierarchy, it obtains data corresponding to the SCADA server 412 in the information technology network 404 from switch 416-3, and finally data corresponding to the HMI 414 from switch 416-4. These data sets are correlated to ensure they represent the same process variables across different network segments.

The system 210 then performs a detailed comparison of these time-series data sets. In this scenario, during comparison, the system 210 notices a critical inconsistency between the time-series data set, i.e., while the data from the field devices 408, PLC/RTU 410, and SCADA server 412 (representing the lower layers of the industrial control network 400) show dynamic variable values that change over time as expected, the HMI 414 (representing the higher layer of the industrial control network 400) displays static values for a pre-defined duration. Based on this detection, the system 210 identifies that there is a discrepancy localized at the HMI 414 (depicted by reference numeral 418 in FIG. 4). The system 210 infers that this is likely due to a connection line fault resulting in a data flow interruption between the SCADA server 412 and the HMI 414, rather than a cyber-attack or data manipulation, because the inconsistency is isolated to the final segment of the industrial control network 400.

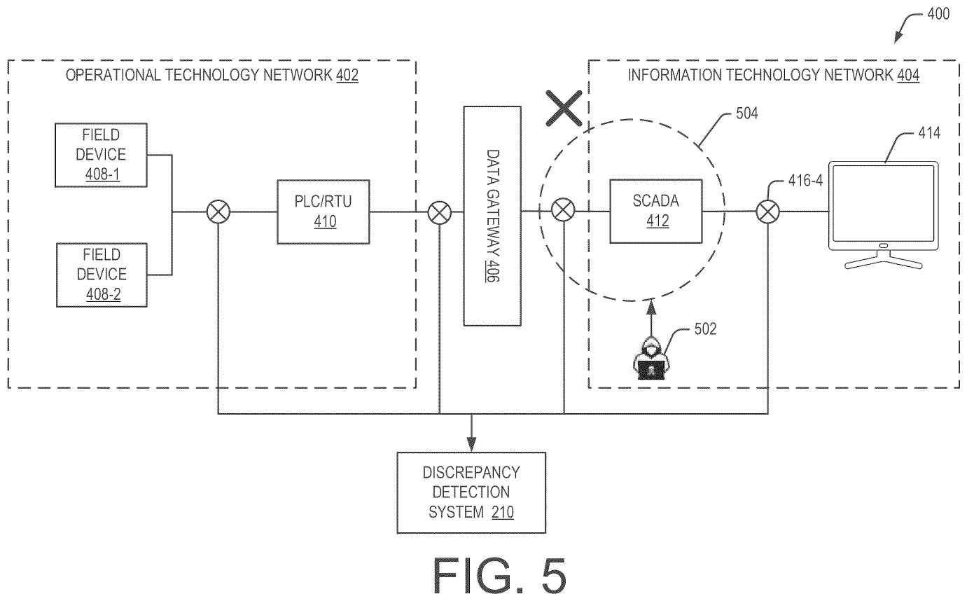

FIG. 5 also depicts the industrial control network 400 illustrating another scenario where an intruder 502 has successfully infiltrated the industrial control network 400, specifically targeting either the SCADA server 412 or the preceding network switch 416-3 to manipulate variable values (the location of intrusion is marked by reference numeral 504).

In such a scenario, the system 210 initiates its analysis by obtaining and generating correlated pairs of time-series data sets corresponding to different segments of the industrial control network 400. For example, it collects data from the field devices 408-1 and 408-2, representing the ground truth of the physical processes. It then gathers data from the PLC/RTU 410, which should reflect processed versions of the field device data. Finally, it obtains data from the SCADA server 412 and the HMI 414. These data sets are carefully time-synchronized and correlated to ensure they represent the same process variables across different network layers.

The system 210 then performs a detailed comparison of the variable values within these correlated pairs of time-series data set. Based on the comparison, the system 210 detects significant inconsistencies between the values reported by the SCADA server 412 and those from lower levels of the industrial control network 400, particularly the PLC/RTU 410 and field devices 408-1 and 408-2. These inconsistencies persist even though the data should represent the same process variables. The system 210 analyzes the nature of this discrepancy, considering factors such as the magnitude of differences, temporal patterns, and relationships between variables. Based on this comprehensive analysis, the system 210 infers that the discrepancy is likely due to deliberate data manipulation rather than random errors or system malfunctions. Once discrepancy is identified, the system 210 pinpoints the location of the discrepancy to the SCADA server 412 or its associated network switch 416-3, indicating a probable intrusion or cyber-attack targeting this critical component of the industrial control network 400.

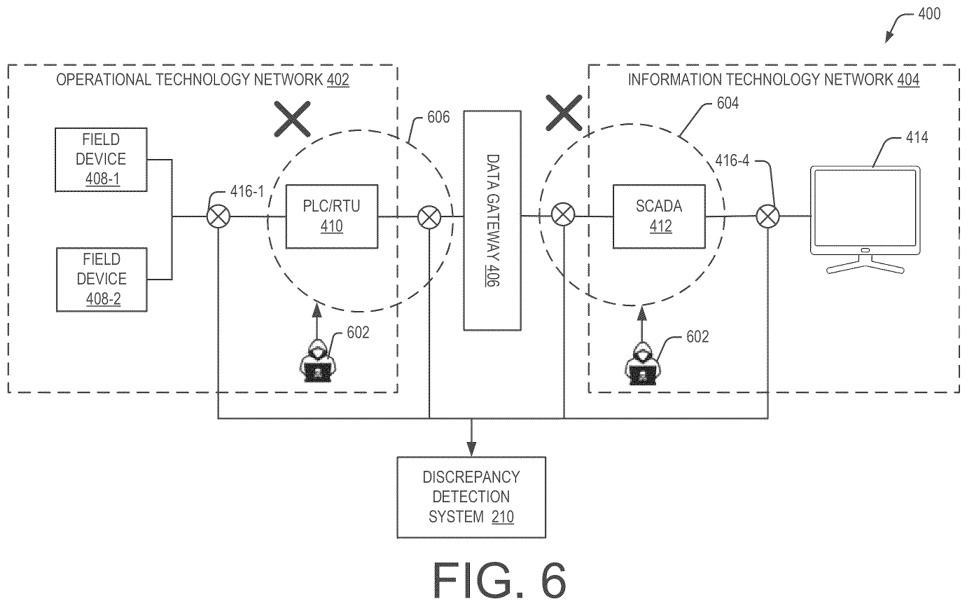

FIG. 6 also depicts industrial control network 400 illustrating a scenario where intrusion has been performed by an intruder 602 at multiple locations, e.g., at location 604 and location 606, within the industrial control network 400. In this case, the intruder 602 has managed to compromise multiple points in the network demonstrating a level of access and understanding that poses a severe threat to the entire industrial control network 400. In this scenario, firstly, the intruder intercepts the PLC/RTU 410 to inject harmful instructions for manipulating the operation of the field devices 408-1 and 408-2, and then manipulates data at the SCADA server 412 to conceal this initial manipulation.

In such a scenario, the system 210 begins by obtaining comprehensive time-series data sets from all segments of the industrial control network 400. This includes raw data from the field devices 408-1 and 408-2, processed data and control signals from the PLC/RTU 410, and higher-level data from the SCADA server 412 and HMI 414. The system 210 carefully correlates these data sets, ensuring that they represent the same process variables across different network layers and are properly time-synchronized.

The system 210 then conducts a multi-layered analysis of the correlated data sets. First, it identifies a discrepancy at the SCADA server level, where the manipulated variable value doesn't match the expected values based on lower-level readings or readings from other segments. However, the analysis doesn't stop there. The system 210 also examines the behavior of process variables over time, particularly at the PLC level. It detects that certain variables, such as temperature, are not changing as expected based on known process dynamics and control logic. This combination of discrepancies-manipulated data at the SCADA level and unexpected behavior at the PLC level-allows the system 210 to infer the presence of intrusions at both points in the network.

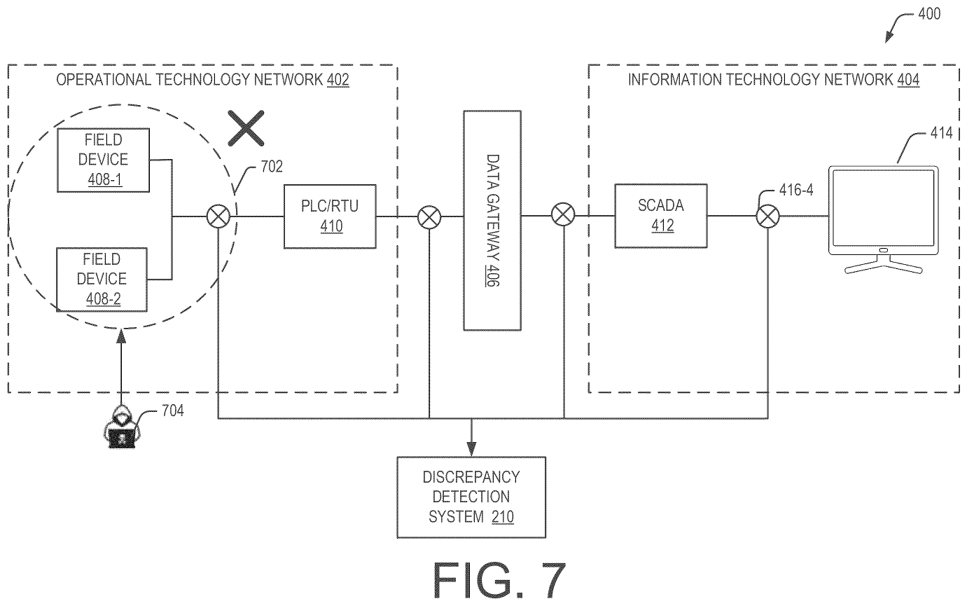

FIG. 7 also depicts the industrial control network 400 illustrating another scenario for discrepancy detection within the industrial control network 400. In this case, a discrepancy occurs at the lowest level of the network hierarchy, specifically at the field devices 408-1 or 408-2 (depicted by point of attack 702), either due to an intrusion by attacker 704 or a sensor malfunction. This situation is especially difficult to detect because the altered values propagate consistently across all network segments, appearing as valid data throughout the industrial control network 400.

In such a scenario, the system 210 begins its analysis by obtaining time-series data sets from all segments of the industrial control network 400, including the field devices 408-1 and 408-2, the PLC/RTU 410, the SCADA server 412, and the HMI 414. It correlates these data sets and performs its standard comparison across network segments. Initially, this comparison doesn't reveal any discrepancies because the altered values are consistent from the field level all the way up to the HMI 414. However, the system 210 doesn't stop its analysis at this point. Instead, it activates additional, more advanced detection mechanisms.

In one example, the system 210 uses a historical data, such as historical data 326 from a data historian, such as data historian 214, to perform analysis. As described above as well, the historical data 326 includes a plurality of baseline time-series data sets that represent the normal behavior of process variables under various operating conditions. The system 210 compares the current time-series data set against these baseline patterns or time-series data set, to detect subtle deviations between the current time-series data set and baseline time-series data sets indicating discrepancy.

In another example, the system 210 may perform an analysis of relationships between different process variables. For example, the system 210 examines how changes in one variable typically affect others based on the physical and operational characteristics of the industrial process. In an example, if the system 210 detects discrepancies in related variables while the target variable remains suspiciously consistent, it may infer the presence of a discrepancy even when direct comparisons don't reveal issues.

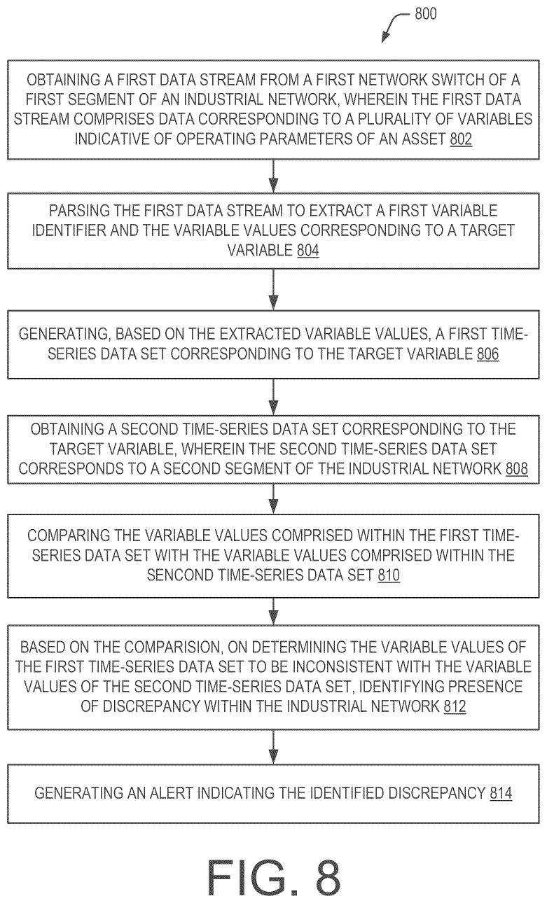

Further, the nature of these related discrepancies helps the system 210 to distinguish between an intrusion (where multiple related variables might show coordinated anomalies) and a sensor malfunction (where only the malfunctioning sensor's data would be affected). The methods for identifying discrepancies within the industrial control network are further described in conjunction with FIG. 8-10.

FIG. 8 illustrates a method 800 for identifying a presence of discrepancy within an industrial control network, as per an example. The discrepancy is indicative of at least one of an intrusion in the industrial control network, a cyber-attack, a network failure, a communication error, a sensor malfunction, and a process anomaly, or combination thereof. The order in which the method 800 is described is not intended to be construed as a limitation, and some of the described method blocks may be combined in a different order to implement the method, or an alternative method.

Furthermore, the method 800 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 800 may be implemented by a discrepancy detection system, such as system 210, as shown in FIG. 2 and FIG. 3. In an implementation, the method may be performed under an “as a service” delivery model, where the system 210, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 800 may be implemented by the system 210 for identifying the presence of discrepancy within the industrial control network. At block 802, a first data stream is obtained from a first network switch of a first segment of an industrial control network. The first data stream includes data corresponding to a plurality of variables indicative of operating parameters of an asset installed within the industrial facility. For example, the transceiver engine 312 of the system 210 obtains a first data stream from the network switch 208-1 associated with the first segment, which may be ‘segment 0’ (i.e., the field level segment). This first data stream may include information from field devices such as field device(s) 202, containing raw sensor data like temperature readings, pressure measurements, flow rates, and equipment status indicators.

At block 804, the first data stream is parsed to extract a first variable identifier and the variable values corresponding to a target variable. For example, the detection engine 212 parses the first data stream to extract variable identifiers and their corresponding values. These variable identifiers may include unique tags or addresses for specific sensors or field devices (e.g., “TT101” for a temperature transmitter, “FT202” for a flow transmitter). The corresponding values would be the actual measurements or states of these devices (e.g., 85.5° C. for TT101, 500 L/min for FT202).

At block 806, based on the extracted variable values, a first time-series data set corresponding to the target variable is generated. For example, the detection engine 212 generates a first time-series data set based on the extracted variable values, where each time-series corresponds to a specific variable identifier and contains a sequence of values over time. This time-series data set represents how the target variable's values change over time within the first segment of the network.

At block 808, a second time-series data set corresponding to the target variable is obtained. The second time-series data set corresponds to a second segment of the industrial control network. For example, the transceiver engine 312 obtains a second data stream from another network switch 208-3 associated with the second segment, which may be ‘segment 1’ (i.e., at the control level segment) including data from PLCs such as PLC(s) 204. This second time-series data set might represent processed data from PLCs, including control signals, setpoints, and calculated process variables for the same target variable.

At block 810, the variable values comprised within the first time-series data set is compared with the variable values comprised within the second time-series data set. For example, the detection engine 212 compares the variable values included within the first target time-series data set with the variable values included within the second target time-series data set. This comparison is performed point by point across the time-series, analyzing how the values of the target variable change or remain consistent as they move through different segments of the network 200.

At block 812, based on the comparison, on determining the variable values of the first time-series data set to be inconsistent with the variable values of the second time0-series data set, presence of discrepancy within the industrial control network is identified. For example, if the detection engine 212 determines that the variable values in the first target time-series data set are inconsistent with the values in the second target time-series data set, it identifies the presence of a discrepancy within the network 200. Inconsistencies may include unexpected deviations, delays, or alterations in the data as it moves from one segment to another.

At block 814, an alert indicating the identified discrepancy is generated. For example, upon identifying a discrepancy, the detection engine 212 generates an alert to indicate the detected issue. This alert may be sent to the HMI for immediate operator attention, logged in the data historian 214 for future analysis, or transmitted to other relevant systems within the network 200. The alert may include details about the nature of the discrepancy, its location within the network, and potential implications for system operation or security.

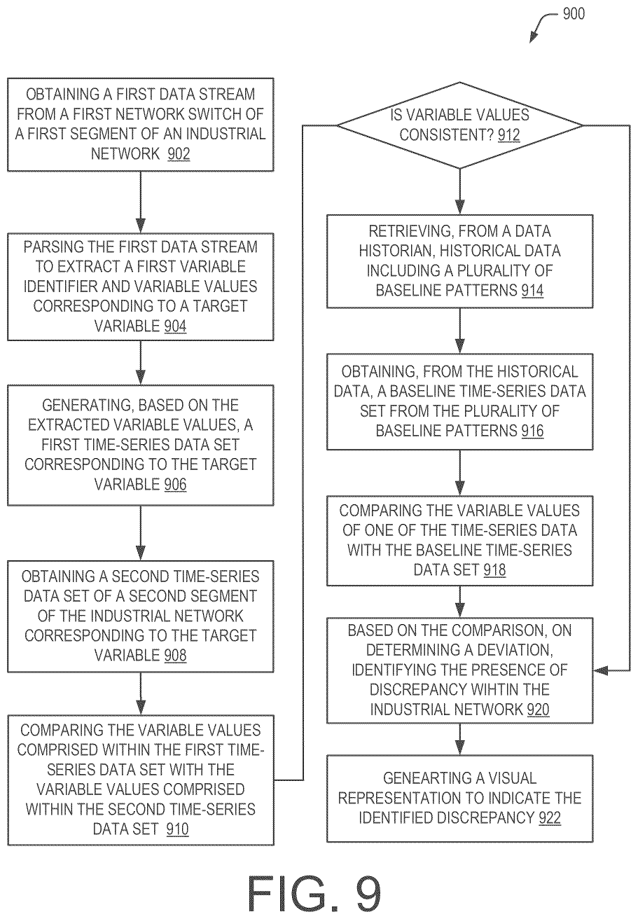

FIG. 9 illustrates a method 900 for identifying a presence of discrepancy within an industrial control network, as per an example. The method 900 is a detailed version of method 800 explaining additional steps for identifying the presence of discrepancy. The order in which the method 900 is described is not intended to be construed as a limitation, and some of the described method blocks may be combined in a different order to implement the method, or an alternative method.

Furthermore, the method 900 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 900 may be implemented by a discrepancy detection system, such as system 210, as shown in FIG. 2 and FIG. 3. In an implementation, the method may be performed under an “as a service” delivery model, where the system 210, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 900 may be implemented by the system 210 for identifying the presence of discrepancy within the industrial control network. At block 902, a first data stream is obtained from a first network switch of a first segment of the industrial control network. For example, the transceiver engine 312 of the system 210 obtains a first data stream from the network switch 208-1 associated with the first segment, which may be ‘segment 0’ (i.e., the field level segment). This first data stream may include information from field devices such as field device(s) 202, containing raw sensor data like temperature readings, pressure measurements, flow rates, and equipment status indicators.

At block 904, the first data stream is parsed to extract a first variable identifier and variable values corresponding to a target variable. For example, the detection engine 212 parses the first data stream to extract variable identifiers and their corresponding values. These variable identifiers may include unique tags or addresses for specific sensors or field devices (e.g., “TT101” for a temperature transmitter, “FT202” for a flow transmitter). The corresponding values would be the actual measurements or states of these devices (e.g., 85.5° C. for TT101, 500 L/min for FT202).

At block 906, based on the extracted values, a first time-series data set corresponding to the target variable is generated. For example, the detection engine 212 generates a first time-series data set based on the extracted variable values, where each time-series corresponds to a specific variable identifier and contains a sequence of values over time. This time-series data set represents how the target variable's values change over time within the first segment of the network.

At block 908, a second time-series data set of a second segment of the industrial control network and corresponding to the target variable is obtained. For example, the transceiver engine 312 obtains a second data stream from another network switch 208-3 associated with the second segment, which may be ‘segment 1’ (i.e., at the control level segment) including data from PLCs such as PLC(s) 204. This second time-series data set might represent processed data from PLCs, including control signals, setpoints, and calculated process variables for the same target variable.

At block 910, the variable values comprised within the first time-series data set are compared with the variable values comprised within the second time-series data set. For example, the detection engine 212 compares the variable values included within the first target time-series data set with the variable values included within the second target time-series data set. This comparison is performed point by point across the time-series, analyzing how the values of the target variable change or remain consistent as they move through different segments of the network 200.

At block 912, a determination is made whether the variable values of the first and the second time-series data sets are consistent. For example, if it is determined that the variable values in the first time-series data set are inconsistent with the values in the second time-series data set, the detection engine 212 identifies the presence of a discrepancy within the network 200 and the method proceeds to block 920 (‘No’ path from block 912). Examples of inconsistencies include, but are not limited to, unexpected deviations, delays, or alterations in the data as it moves from one segment to another. For example, if a temperature sensor in the field device segment (‘segment 0’) reports a gradual increase from 25° C. to 30° C. over a 5-minute period, but the corresponding data in the PLC segment (‘segment 1’) shows a sudden jump from 25° C. to 30° C., this inconsistency in the rate of change may indicate a communication error, data manipulation, or a fault in the data transmission process between the two segments.

On the other hand, upon determining that the variable values of the first time-series data set (from ‘segment 0’) are consistent with the values of the second time-series data set (from ‘segment 1’), the detection engine 212 analyse the current time-series data set (i.e., first time-series data set or second time-series data set) with historical data 326 retrieved from the data historian 214 and the method proceeds to block 914 (‘Yes’ path from block 912).

At block 914, historical data including a plurality of baseline time-series data sets is retrieved from a data historian. For example, upon determining that the variable values of the first time-series data set (from ‘segment 0’) are consistent with the values of the second time-series data set (from ‘segment 1’), the detection engine 212 analyse the current time-series data set (i.e., first time-series data set or second time-series data set) with historical data 326 retrieved from the data historian 214. In an example, the historical data 326 comprises multiple baseline time-series data sets or patterns that represent normal or expected behavior for various variables across different assets in the network 200.

At block 916, a baseline time-series data set corresponding to the target variable is obtained from the plurality of baseline time-series data sets. For example, the detection engine 212 obtains a specific baseline time-series data set from the historical data 326 that corresponds to the target variable being analyzed. In an example, the historical data 326 comprises multiple baseline time-series data sets that represent normal or expected behavior for various variables across different assets in the network 200. The detection engine 212 then uses this historical data 326 in combination with the current first and second time-series data sets to identify potential discrepancies that may not be apparent from just comparing the two current data sets with the baseline data set.

At block 918, the variable values of one of the time-series data sets are compared with the baseline time-series data. For example, the detection engine 212 then compares the variable values of either the first or second time-series data set (or both) against this baseline time-series data set. In an example, this comparison is performed point by point across the time-series, analyzing how the values of the target variable change or remain consistent as they move through different segments of the network 200.

At block 920, based on the comparison, on determining a deviation, a presence of discrepancy is identified within the industrial control network. For example, based on the comparison, if the detection engine 212 detects a significant deviation between the current data and the historical baseline, it identifies this as a discrepancy within the network 200, even though the current data from different segments appeared consistent, and generate the alert indicating the discrepancy.

In yet another example, the system 210 may perform a more sophisticated analysis by considering relationships between variables. For example, even when the time-series data set for the target variable appears consistent across segments, the detection engine 212 retrieves relationship data from the data historian 214. This relationship data indicates how the target variable typically correlates with other variables in the industrial process. The detection engine 212 then analyzes the values of these related variables across different segments. If inconsistencies are detected in these related variables, the detection engine 212 may infer that a discrepancy exists in the target variable, despite its apparent consistency.

At block 922, a visual representation is generated to indicate the identified discrepancy. For example, the detection engine 212 of the system 210 may generates a comprehensive visual representation on the HMI or another user interface. In an example, this visualization representation includes a timeline displaying both the first and second target time-series data sets, allowing operators to see how the data evolves over time across different segments. In another example, color-coded indicators may also be used as visual representation to highlight discrepancies, making them easily noticeable. Further, icons representing different network segments (such as field devices 202-1 to 202-N, PLCs 204-1 to 204-N, and SCADA server 206) are included to provide context for where discrepancies occur within the network topology. In another example, animated data flow paths visually demonstrate how data moves through the network and pinpoint exact locations where discrepancies arise. For more detailed information, the interface includes interactive pop-ups that provide specific details about each discrepancy and a severity scale to help prioritize responses.

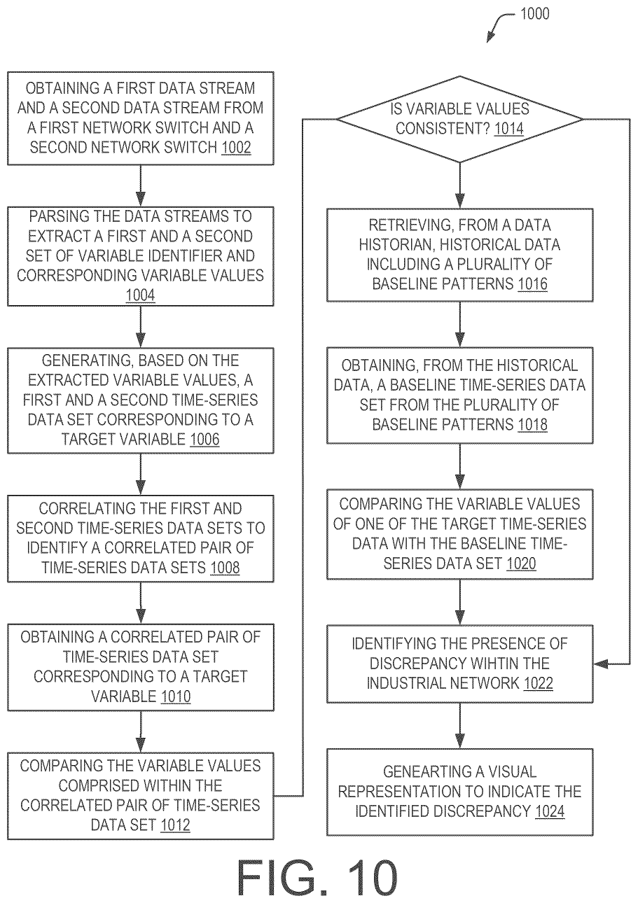

FIG. 10 illustrates a method 1000 for identifying a presence of discrepancy within an industrial control network, as per an example. The discrepancy is indicative of at least one of an intrusion in the industrial control network, a cyber-attack, a network failure, a communication error, a sensor malfunction, and a process anomaly, or combination thereof. The order in which the method 1000 is described is not intended to be construed as a limitation, and some of the described method blocks may be combined in a different order to implement the method, or an alternative method.

Furthermore, the method 1000 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 1000 may be implemented by a discrepancy detection system, such as system 210, as shown in FIG. 2 and FIG. 3. In an implementation, the method may be performed under an “as a service” delivery model, where the system 210, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 1000 may be implemented by the system 210 for identifying the presence of discrepancy within the industrial control network. At block 1002, a first data stream and a second data stream are obtained from a first network switch and a second network switch, respectively. For example, the transceiver engine 312 of the system 210 is configured to obtain a first data stream and a second data stream from network switch(s) 208 corresponding to first and second segments of the network 200. The system 210 stores these obtained data streams in data stream(s) 316 of data 310. Specifically, a first data stream is obtained from the network switch 208-1 associated with the first segment, which may be ‘segment 0’ (i.e., the field level segment). In an example, the first data stream may include information from field devices such as field device(s) 202. Simultaneously, a second data stream is obtained from another network switch 208-3 which may be associated with the second segment, which may be ‘segment 1’ (i.e., at the control level segment) including data from PLCs such as PLC(s) 204.

In an example, the data stream(s) 316 comprise information corresponding to a plurality of variables that are indicative of operating parameters of various assets within the industrial facility. For instance, the first data stream from ‘segment 0’ might include raw sensor data from field devices, such as temperature readings, pressure measurements, flow rates, and equipment status indicators. The second data stream from ‘segment 1’ may include processed data from PLC(s) 204, including control signals, setpoints, and calculated process variables.

At block 1004, the data streams are parsed to extract a first and a second set of variable identifiers and corresponding variable values. For example, the system 210, through its detection engine 212, is configured to parse the obtained data stream(s) 316. When parsing the first data stream from the network switch 208-1 in ‘segment 0’, the detection engine 212 extracts a first set of variable identifiers and their corresponding values. In an example, these variable identifiers may include unique tags or addresses for specific sensors or field devices (e.g., “TT101” for a temperature transmitter, “FT202” for a flow transmitter). The corresponding values would be the actual measurements or states of these devices (e.g., 85.5° C. for TT101, 500 L/min for FT202).

Similarly, when parsing the second data stream from the network switch 208-3 in ‘segment 1’, the detection engine 212 extracts a second set of variable identifiers and their corresponding values. At this level, the variable identifiers may be PLC memory addresses or tag names (e.g., “DB1.DBW0” for a data block in a Siemens PLC, or “Tank1_Level” for a named variable). The corresponding values would be the processed or calculated values used by the PLCs (e.g., a scaled temperature value, a control output percentage). The system 210 stores the first set of variable identifiers and the second set of variable identifiers in the variable identifier(s) 318 of the data 310. Correspondingly, the system 210 stores the variable values associated with the first set of variable identifiers and the second set of variable identifiers in the variable value(s) 320 of the data 310.

At block 1006, based on the extracted variable values, a first and a second time-series data set is generated corresponding to a target variable. For example, the detection engine 212 generates time-series data sets based on the extracted variable value(s) 320. For the first set of variable identifiers from ‘segment 0’, the detection engine 212 creates a first set of time-series data sets. In an example, each time-series in this set corresponds to a specific variable identifier (e.g., a sensor tag) and contains a sequence of values over time. Similarly, for the second set of variable identifiers from ‘segment 1’, the detection engine 212 generates a second set of time-series data set, each corresponding to a PLC variable or tag. For example, a time-series in the first set might represent temperature readings from a specific sensor (field device 202-1) over time, while a time-series in the second set might represent the processed temperature values used by a PLC (PLC 204-1) for the same process variable. The system 210 stores the first set of time-series data set and the second set of time-series data set in the time-series data set(s) 322 of the data 310.

At block 1008, the first and the second time-series data sets are correlated to identify a correlated pair of time-series data sets including a first target time-series data set and a second target time-series data set. For example, the detection engine 212 correlates the first set of time-series data set with the second set which are stored in the time-series data set(s) 322. In an example, this correlation process involves identifying pairs of time-series data sets that likely represent the same underlying process variable as it moves through different segments of the network 200. For instance, it might correlate the raw temperature sensor readings from ‘segment 0’ with the processed temperature values used by the PLC in ‘segment 1’. The result of this correlation is a set of paired time-series data set, where each pair consists of a “first target time-series data set” selected from the first set of time-series data set and a “second target time-series data set” selected from the second set of time-series data set. These correlated pairs represent the same process variables as observed at different points in the network 200, enabling the system 210 to track how data changes as it moves through the network hierarchy. The system 210 stores the set of paired time-series data sets in paired time-series data set(s) 324 of the data 310.

At block 1010, a correlated pair of time-series data set corresponding to a target variable is obtained from the correlated pair of time-series data sets. For example, the detection engine 212 obtains a correlated pair of time-series data set from the paired time-series data set(s) 324 corresponding to a target variable. This correlated pair comprises a first target time-series data set and a second target time-series data set corresponding to the first segment and the second segment, respectively, of the network 200. Both data sets in the pair correspond to the same target variable and contain values of that variable for a specific asset over the defined time period.

At block 1012, the variable values comprised within the correlated pair of time-series data sets are compared. For example, the detection engine 212 compares the variable values included within the first target time-series data set (e.g., raw sensor data from the field device 202-1 in ‘segment 0’) with the variable values included within the second target time-series data set (e.g., processed data from the PLC 204-1 in ‘segment 1’). As described above, the paired time-series data set(s) 324 includes one or more pair of time-series data sets, from which a single pair, corresponding to a target variable, is selected and variable values comprised within respective time-series data sets of the pair are compared. In an example, this comparison is performed point by point across the time-series, analyzing how the values of the target variable change or remain consistent as they move through different segments of the network 200.

At block 1014, a determination is made whether the variable values of the first and the second target time-series data sets are consistent. For example, if it is determined that the variable values in the first target time-series data set are inconsistent with the values in the second target time-series data set, the detection engine 212 identifies the presence of a discrepancy within the network 200 and the method proceeds to block 1022 (‘No’ path from block 1014). Examples of inconsistencies include, but are not limited to, unexpected deviations, delays, or alterations in the data as it moves from one segment to another. For example, if a temperature sensor in the field device segment (‘segment 0’) reports a gradual increase from 25° C. to 30° C. over a 5-minute period, but the corresponding data in the PLC segment (‘segment 1’) shows a sudden jump from 25° C. to 30° C., this inconsistency in the rate of change may indicate a communication error, data manipulation, or a fault in the data transmission process between the two segments.

On the other hand, upon determining that the variable values of the first target time-series data set (from ‘segment 0’) are consistent with the values of the second target time-series data set (from ‘segment 1’), the detection engine 212 analyse the current time-series data set (i.e., first time-series data set or second time-series data set) with historical data 326 retrieved from the data historian 214 and the method proceeds to block 1016 (‘Yes’ path from block 1014).

At block 1016, historical data is retrieved from a data historian. For example, upon determining that the variable values of the first target time-series data set (from ‘segment 0’) are consistent with the values of the second target time-series data set (from ‘segment 1’), the detection engine 212 analyse the current time-series data set (i.e., first time-series data set or second time-series data set) with historical data 326 retrieved from the data historian 214. In an example, the historical data 326 comprises multiple baseline time-series data sets that represent normal or expected behavior for various variables across different assets in the network 200.

At block 1018, a baseline time-series data set is obtained from the plurality of baseline time-series data sets. For example, the detection engine 212 obtains a specific baseline time-series data set from the historical data 326 that corresponds to the target variable being analyzed. In an example, the historical data 326 comprises multiple baseline time-series data sets that represent normal or expected behavior for various variables across different assets in the network 200. The detection engine 212 then uses this historical data 326 in combination with the current first and second target time-series data sets to identify potential discrepancies that may not be apparent from just comparing the two current data sets with the baseline data set.

At block 1020, variables values of one of the target time-series data set are compared with the baseline time-series data set. For example, the detection engine 212 then compares the variable values of either the first or second target time-series data set (or both) against this baseline time-series data set. In an example, this comparison is performed point by point across the time-series, analyzing how the values of the target variable change or remain consistent as they move through different segments of the network 200.

At block 1022, a presence of a discrepancy is identified within the industrial control network. For example, based on the comparison, if the detection engine 212 detects a significant deviation between the current data and the historical baseline, it identifies this as a discrepancy within the network 200, even though the current data from different segments appeared consistent, and generate the alert indicating the discrepancy.

In yet another example, the system 210 may perform a more sophisticated analysis by considering relationships between variables. For example, even when the time-series data set for the target variable appears consistent across segments, the detection engine 212 retrieves relationship data from the data historian 214. This relationship data indicates how the target variable typically correlates with other variables in the industrial process. The detection engine 212 then analyzes the values of these related variables across different segments. If inconsistencies are detected in these related variables, the detection engine 212 may infer that a discrepancy exists in the target variable, despite its apparent consistency.

At block 1024, a visual representation is generated to indicate the identified discrepancy. For example, the detection engine 212 of the system 210 may generates a comprehensive visual representation on the HMI or another user interface. In an example, this visualization representation includes a timeline displaying both the first and second target time-series data sets, allowing operators to see how the data evolves over time across different segments. In another example, color-coded indicators may also be used as visual representation to highlight discrepancies, making them easily noticeable. Further, icons representing different network segments (such as field devices 202-1 to 202-N, PLCs 204-1 to 204-N, and SCADA server 206) are included to provide context for where discrepancies occur within the network topology. In another example, animated data flow paths visually demonstrate how data moves through the network and pinpoint exact locations where discrepancies arise. For more detailed information, the interface includes interactive pop-ups that provide specific details about each discrepancy and a severity scale to help prioritize responses.

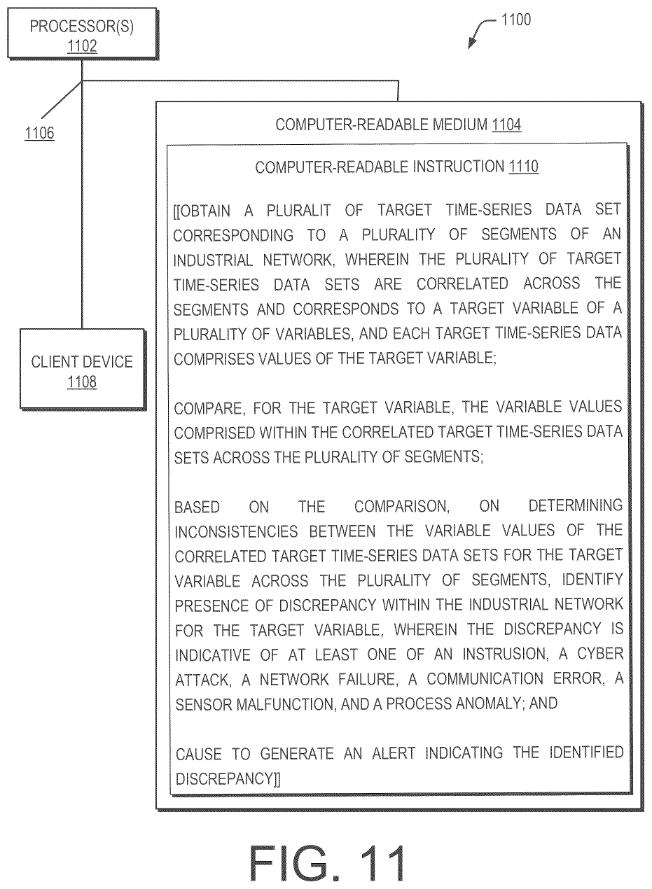

FIG. 11 illustrates a computing environment 1100 implementing a non-transitory computer-readable medium for detecting discrepancies in an industrial control network. The computing environment 1100 includes processor(s) 1102 communicatively coupled to a non-transitory computer-readable medium 1104 through a communication link 1106. The processor(s) 1102 may have one or more processing resources for fetching and executing computer-readable instructions from the non-transitory computer-readable medium 1104.

The non-transitory computer-readable medium 1104 may be, for example, an internal memory device or an external memory device. In an example implementation, the communication link 1106 may be a network communication link. The processor(s) 1102 and the non-transitory computer-readable medium 1104 may also be communicatively coupled to a client device 1108 over the network.

In an example implementation, the non-transitory computer-readable medium 1104 includes a set of computer-readable instructions 1110 (referred to as instructions 1110) which may be accessed by the processor(s) 1102 through the communication link 1106. The instructions 1110 cause the processor(s) 1102 to obtain a plurality of target time-series data sets corresponding to a plurality of segments of the industrial control network. These target time-series data sets are correlated across the segments and correspond to a target variable of a plurality of variables, with each target time-series data set comprising values of the target variable.

To obtain the plurality of target time-series data sets, the instructions 1110 may cause the processor(s) 1102 to perform several steps. First, they obtain a plurality of data streams from network switches corresponding to the plurality of segments of the industrial control network. Each of these data streams contains data related to multiple variables indicative of operating parameters of assets within the network. The processor(s) 1102 then parse each data stream to extract variable identifiers and their corresponding values. Based on these extracted values, the processor(s) 1102 generate multiple time-series data sets corresponding to the extracted variable identifiers. Finally, these time-series data sets are correlated to identify the target time-series data sets, with each set selected from the generated time-series data set for each segment.

In an example, the plurality of segments in the industrial control network may comprise various equipment such as programmable logic controllers (PLCs), remote terminal units (RTUs), sensors, actuators, field devices, human-machine interfaces (HMI), supervisory control and data acquisition (SCADA) servers, historians, and engineering workstations. This diverse range of equipment allows for comprehensive monitoring across different levels or segments of the industrial control system.

The instructions 1110 further cause the processor(s) 1102 to identify discrepancies that may indicate issues such as intrusions in the industrial control network, cyber-attacks, network failures, communication errors, sensor malfunctions, or process anomalies. This identification process involves comparing the variable values within the correlated target time-series data sets across the plurality of segments for the target variable.

If inconsistencies are detected between the variable values of the correlated target time-series data sets across the plurality of segments, the instructions 1110 cause the processor(s) 1102 to identify the presence of a discrepancy within the industrial control network for the target variable. Upon identifying a discrepancy, the processor(s) 1102 generate an alert to indicate the identified discrepancy.

In an example, to enhance the visualization of detected discrepancies, the instructions 1110 may cause the processor(s) 1102 to generate a visual representation on a user interface. This visual representation includes several elements to effectively communicate the nature and severity of the discrepancy. It features a timeline of the target time-series data sets, allowing for temporal analysis of the discrepancy. Color-coded discrepancy indicators provide quick visual cues about the severity or type of discrepancy. Icons representing different network segments help localize the issue within the network topology. Animated data flow paths visually demonstrate where discrepancies occur in the data transmission process. Interactive pop-ups offer detailed information about each discrepancy, including a severity scale to prioritize responses.

By implementing these instructions, the system can process various types of data streams and perform advanced analytics to detect discrepancies across multiple segments of the industrial control network. This comprehensive approach to monitoring industrial processes significantly enhances the ability to identify and respond to potential issues that may affect the integrity, security, or efficiency of the industrial control system.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

I/We claim:

1. A system comprising:
a processor; and
a machine-readable storage medium comprising instructions executable by the processor to:
obtain a correlated pair of time-series data set comprising a first target time-series data set and a second target time-series data set corresponding to a first segment and a second segment, respectively, of an industrial control network, wherein the first and second target time-series data sets corresponds to a target variable of a plurality of variables, and comprises values of the target variable for an asset over time;
comparing the values of the target variable comprised within the first target time-series data set with the values comprised within the second target time-series data set;
on determining the variable values of the first target time-series data set to be inconsistent with the variable values of the second target time-series data set, identify presence of a discrepancy within the industrial control network, wherein the discrepancy is indicative of at least one of: an intrusion, a cyber-attack, a network failure, a communication error, a sensor malfunction, and a process anomaly; and
cause to generate an alert indicating the identified discrepancy.

2. The system as claimed in claim 1, wherein the first segment and the segment comprise one or more equipment selected from one of programmable logic controller (PLCs), remote terminal units (RTUs), sensors, actuators, field devices, human-machine interfaces (HMI), supervisory control and data acquisition (SCADA) servers, historians, engineering workstations, or combination thereof.

3. The system as claimed in claim 1, wherein to obtain a correlated pair of time-series data set, the instructions are executable by the processor to:
obtain a first data stream and a second data stream from a first network switch and a second network switch corresponding to the first segment and the second segment, respectively, of the industrial control network, wherein the first data stream and the second data stream comprises data corresponding to a plurality of variables indicative of operating parameters of the asset;
parse the first data stream to extract a first set of variable identifiers and corresponding variable values, and the second data stream to extract a second set of variable identifiers and corresponding variable values;
generate, based on the variable values, a first set of time-series data set corresponding to the first set of variable identifiers and a second set of time-series data set corresponding to the second set of variable identifiers; and
correlate the first set of time-series data set and the second set of time-series data set to identify the correlated pair of time-series data set, wherein the correlated pair of time-series data set comprises the first target time-series data set selected from the first set of time-series data set and the second target time-series data set selected from the second set of time-series data set.

4. The system as claimed in claim 1, wherein when the first segment corresponds to a lower layer and the second segment corresponds to a higher layer of the industrial control network, to identify a discrepancy, the instructions are further executable by the processor to:
based on the comparison of the first target time-series data set with the second target time-series data set, detect a pattern where the second time-series data set exhibits static values over a pre-defined duration while the first time-series data set shows dynamic values during the same pre-defined duration; and
based on the pattern, identify the discrepancy of a data flow interruption within the industrial control network.

5. The system as claimed in claim 1, wherein the instructions are further executable by the processor to:
on determining the values of the target variable comprised within the first target time-series data set to be consistent with the values of the target variable comprised within the second target time-series data set, retrieve, from a data historian, historical data comprising a plurality of baseline time-series data sets indicative of actual behavior of the plurality of variables for a plurality of assets of the industrial control network; and
identify the discrepancy within the industrial control network based on the historical data in combination with the first and second target time-series data set.

6. The system as claimed in claim 5, wherein to identify the discrepancy based on the historical data, the instructions are further executable by the processor to:
obtain, from the historical data, a baseline time-series data set from the plurality of baseline time-series data sets, wherein the baseline time-series data set is indicative of actual time-series data set corresponding to the target variable;
compare the values of the target variable comprised within one of the target time-series data sets with the values comprised within the baseline time-series data set; and
on determining a deviation in the values of the target variable of one of the target time-series data set with respect to the values comprised within the baseline time-series data set, identify the presence of discrepancy within the industrial control network.

7. The system as claimed in claim 1, wherein the instructions are further executable by the processor to:
on determining the values of the target variable comprised within the first target time-series data set to be consistent with the values of the target variable comprised within the second target time-series data set, obtain, from a data historian, a relationship data indicating relationship of the target variable with the plurality of variables; and
based on the relationship data, determine that the discrepancy exists within the target variable based on the inconsistences detected in the values of a related variable across the segments, even when the time-series data set for the target variable appears consistent between the first and second segments.

8. The system as claimed in claim 1, wherein the instructions are further executable by the processor to:
generate a visual representation to indicate the discrepancy on a user interface, wherein the visual representation comprises:
a timeline of the first and second target time-series data sets;
color coded discrepancy indicators;
icons for network segments;
animated data flow paths showing discrepancy locations; and
interactive pop-ups with discrepancy details and a discrepancy severity scale.

9. A method comprising:
obtaining a first data stream from a first network switch of a first segment of an industrial control network, wherein the first data stream comprises data corresponding to a plurality of variables indicative of operating parameters of an asset;
parsing the first data stream to extract a first variable identifier and variable values corresponding to a target variable;
generating, based on the variable values, a first time-series data set corresponding to the target variable;
obtaining a second time-series data set corresponding to the target variable, wherein the second time-series data set corresponds to a second segment of the industrial control network;
comparing the variable values comprised within the first time-series data set with the variable values comprised within the second time-series data set;
on determining the variable values of the first time-series data set to be inconsistent with the variable values of the second time-series data set, identifying presence of discrepancy within the industrial control network, wherein the discrepancy is indicative of at least one of: an intrusion in the industrial control network, a cyber-attack, a network failure, a communication error, a sensor malfunction, and a process anomaly; and
generating an alert indicating the discrepancy.

10. The method as claimed in claim 9, wherein the first segment and the second segment comprise one or more equipment selected from one of programmable logic controller (PLCs), remote terminal units (RTUs), sensors, actuators, field devices, human-machine interfaces (HMI), supervisory control and data acquisition (SCADA) servers, historians, engineering workstations, or combination thereof.

11. The method as claimed in claim 9, wherein to obtain a second time-series data set, the method comprises:
obtaining a second data stream from a second network switch of the second segment of the industrial control network, wherein the second data stream comprises data corresponding to the plurality of variables indicative of operating parameters of the asset;
parsing the second data stream to extract a second variable identifier and variable values corresponding to the target variable; and
generating, based on the variable values, the second time-series data set corresponding to the target variable.

12. The method as claimed in claim 9, wherein when the first segment corresponds to a lower layer and the second segment corresponds to a higher layer of the industrial control network, to identify a discrepancy, the method further comprises:
based on the comparison of the variable values comprised within the first time-series data set with the variable values comprised within the second time-series data set, detecting a pattern where the second time-series data set exhibits static values over a pre-defined duration while the first time-series data set shown dynamic values during that pre-defined duration; and
based on the pattern, identifying the discrepancy of a data flow interruption within the industrial control network.

13. The method as claimed in claim 9, wherein the method further comprises:
on determining the variable values of the first target time-series data set to be consistent with the variable values of the second target time-series data set, retrieving, from a data historian, historical data comprising a plurality of baseline time-series data sets indicative of actual behavior of the plurality of variables for a plurality of assets of the industrial control network; and
identifying the discrepancy within the industrial control network based on the historical data in combination with the first and second target time-series data set.

14. The method as claimed in claim 13, wherein to identify the discrepancy, the method comprises:
obtaining, from historical data, a baseline time-series data set from the plurality of baseline time-series data sets indicative of actual behavior of target variable time-series data set corresponding to the target variable;
comparing the variable values of one of the target time-series data sets with the baseline time-series data set; and
on determining a deviation in the variable values of one of the target time-series data sets with respect to the values comprised within the baseline time-series data set, identifying the presence of discrepancy within the industrial control network.

15. The method as claimed in claim 9, wherein the method further comprises:
on determining the variable values of the first time-series data set to be consistent with the variable values of the second time-series data set, obtaining, from a data historian, a relationship data indicating relationship of the target variable with the plurality of variables; and
based on the obtained relationship data, determining that the discrepancy exists within the target variable based on the inconsistences detected in the values of a related variable across the segments, even when the time-series data set for the target variable appears consistent between the first and second segments.

16. The method as claimed in claim 9, wherein the method further comprises:
generating a visual representation to indicate the identified discrepancy on a user interface, wherein the visual representation comprises:
a timeline of the first and second target time-series data sets;
color coded discrepancy indicators;
icons for network segments;
animated data flow paths showing discrepancy locations; and
interactive pop-ups with discrepancy details and a discrepancy severity scale.

17. A non-transitory computer-readable medium comprising instructions, the instructions being executable by a processing resource to:
obtain a plurality of correlated target time-series data sets corresponding to a plurality of segments of an industrial control network, wherein the plurality of target time-series data sets are correlated across the plurality of segments and corresponds to a target variable of a plurality of variables, and each target time-series data set comprises values of the target variable;
compare, for the target variable, the variable values comprised within the plurality of target time-series data sets across the plurality of segments;
on determining inconsistencies between the variable values of the correlated target time-series data sets for the target variable across the plurality of segments, identify presence of discrepancy within the industrial control network for the target variable, wherein the discrepancy is indicative of at least one of: an intrusion in the industrial control network, a cyber-attack, a network failure, a communication error, a sensor malfunction, and a process anomaly; and
cause to generate an alert indicating the discrepancy.

18. The non-transitory computer-readable medium as claimed in claim 17, wherein the plurality of segments comprises one or more equipment selected from one of programmable logic controllers (PLCs), remote terminal units (RTUs), sensors, actuators, field devices, human-machine interfaces (HMI), supervisory control and data acquisition (SCADA) servers, historians, engineering workstations, or combination thereof.

19. The non-transitory computer-readable medium as claimed in claim 17, wherein to obtain a plurality of target time-series data sets, the instructions being executable by the processing resource to:
obtain a plurality of data streams from a plurality of network switches corresponding to the plurality of segments of the industrial control network, wherein each of the plurality of data streams comprises data corresponding to a plurality of variables indicative of operating parameters of an asset;
parse each of the plurality of data streams to extract a plurality of variable identifiers and corresponding variable values;
generate, based on the variable values, a plurality of time-series data sets corresponding to the plurality of variable identifiers; and
correlate the plurality of time-series data sets to identify the correlated target time-series data sets, wherein each time-series data set comprised within the correlated target time-series data sets is selected from each of the plurality of time-series data set.

20. The non-transitory computer-readable medium as claimed in claim 17, the instructions being executable by the processing resource to:
generate a visual representation to indicate the discrepancy on a user interface, wherein the visual representation comprises:
a timeline of the first and second target time-series data sets;
color coded discrepancy indicators;
icons for network segments;
animated data flow paths showing discrepancy locations; and
interactive pop-ups with discrepancy details and a discrepancy severity scale.
